(19) United States
(12) Patent Application Publication
(10) Pub. No.: US 2022/0171044 A1
(43) Pub. Date: Jun. 2, 2022

(54) Improved Critical Distance Monitoring System

(71) Applicant: Clifford Spotts, Oklahoma City (US)

(72) Inventor: Clifford Spotts, Oklahoma City (US)

(21) Appl. No.: 17/436,979

(22) PCT Filed: Feb. 20, 2020
(86) PCT No.: PCT/US20/18941

§ 371 Date: Sep. 7, 2021

Related U.S. Application Data
(60) Provisional application No. 62/819,537, filed on Mar. 16, 2019.

(51) Int. Cl. G01S 11/06; G08B 21/18; G01S 19/13

(52) U.S. Cl. CPC G01S 11/06; G01S 19/13; G08B 21/182

(57) ABSTRACT

Valuable commodities such as cellular telephones are easy to misplace. A system for associating the cellular telephone with another article such that when either the cellular telephone or the article is moved beyond a preset range from one another an alarm sound is provided.

### CROSS-REFERENCE TO RELATED APPLICATIONS

This application takes benefit of U.S. Prov. App. No. 62/819,537 filed Mar. 16, 2019 and incorporates it in its entirety by reference.

### FIELD OF THE INVENTION

Valuable commodities such as cellular telephones are easy to misplace. A system for associating a cellular telephone with another article such that when either the cellular telephone or the article is moved beyond a preset range from one another an alarm sounds is provided.

### BACKGROUND OF THE INVENTION

Today, some cellular telephones cost well in excess of $1,000.00. They have become central to our daily lives. That being said, cellular telephones are not physically attached to humans. They can be mislaid or lost. What is needed is a device that ties the cellular telephone to another article such that when the cellular telephone and the other article are moved beyond a preset distance from one another an alarm is triggered. The alarm can be audible, visual, or tactile.

### SUMMARY OF THE INVENTION

In a first embodiment of the present invention, the improved critical distance monitoring system utilizes a radio frequency (RF) transmitter (e.g. supporting Bluetooth, Wi-fi, or some other wireless data communications protocol) in a dongle attached to a keychain. The cellular telephone receives the signal transmitted by the RF transmitter. When the signal falls below a preset level, the cellular telephone signals an alarm. The alarm can be audible, visual, or tactile.

In a second embodiment of the present invention, the improved critical distance monitoring system utilizes an RF transmitter/receiver attached to the keychain. The cellular telephone receives the signal transmitted by the RF transmitter. When the received signal falls below a preset level, the cellular telephone signals an alarm. The alarm can be audible, visual, or tactile. Simultaneously, the cellular telephone also transmits a signal which is received by the RF transmitter/receiver attached to the keychain. When the signal falls below a preset level, the RF transmitter/receiver attached to the keychain signals an alarm. The alarm can be audible, visual, or tactile.

In a third embodiment of the present invention, the improved critical distance monitoring system utilizes a first RF transmitter/receiver attached to the keychain and a second RF transmitter/receiver in a dongle attached to the cellular telephone. The second RF transmitter/receiver attached to the cellular telephone receives the signal transmitted by the first RF transmitter/receiver attached to the keychain. When the received signal falls below a preset level, the second RF transmitter/receiver attached to the cellular telephone signals an alarm. The alarm can be audible, visual, or tactile. Simultaneously, the first RF transmitter/receiver attached to the keychain receives the signal transmitted by the second RF transmitter/receiver attached to the cellular telephone. When the received signal falls below a preset level, the first RF transmitter/receiver attached to the keychain signals an alarm. The alarm can be audible, visual, or tactile.

In a fourth embodiment of the present invention, the improved critical distance monitoring system utilizes a first RF transmitter/receiver in a dongle attached to a keychain and a second RF transmitter/receiver in a cellular telephone. Both the first and second RF transmitter/receiver are each associated with a GPS receiver. The second RF transmitter/receiver in the cellular telephone receives a signal transmitted by the first RF transmitter/receiver attached to the keychain containing the location of the first RF transmitter/receiver as derived from its associated GPS receiver. When the location of the first RF transmitter/receiver exceeds a preset distance from the second RF transmitter/receiver the cellular telephone signals an alarm. The alarm can be audible, visual, or tactile. Simultaneously, the first RF transmitter/receiver attached to the keychain receives a signal transmitted by the second RF transmitter/receiver in the cellular telephone containing the location of the second RF transmitter/receiver as derived from its associated GPS receiver. When the location of the second RF transmitter/receiver exceeds a preset distance from the first RF transmitter/receiver the first RF transmitter/receiver in a dongle attached to the keychain signals an alarm. The alarm can be audible, visual, or tactile.

### BRIEF DESCRIPTION OF THE DRAWINGS

FIG. 1 is a view of one embodiment of the present invention in which the improved critical distance monitoring system utilizes a radio frequency (RF) transmitter attached to the keychain and the cellular telephone uses an internally constructed RF/receiver to communicate with the RF transmitter/receiver attached to the keychain.

FIG. 2 is a view of another embodiment of the present invention in which the improved critical distance monitoring system utilizes an RF transmitter/receiver attached to the keychain and the cellular telephone uses an internally constructed RF transmitter/receiver to communicate with the RF transmitter/receiver attached to the keychain.

FIG. 3 is a view of another embodiment of the present invention in which the improved critical distance monitoring system utilizes an RF transmitter/receiver attached to the keychain and the cellular telephone uses an externally mounted RF transmitter/receiver to communicate with the RF transmitter/receiver attached to the keychain.

FIG. 4 is a view of another embodiment of the present invention in which the improved critical distance monitoring system utilizes an RF transmitter/receiver attached to the keychain and the cellular telephone uses an internally constructed RF transmitter/receiver to communicate with the RF transmitter/receiver attached to the keychain. Both the RF transmitter/receiver attached to the keychain and the cellular telephone are each affiliated with a GPS receiver.

### DETAILED DESCRIPTION OF THE INVENTION

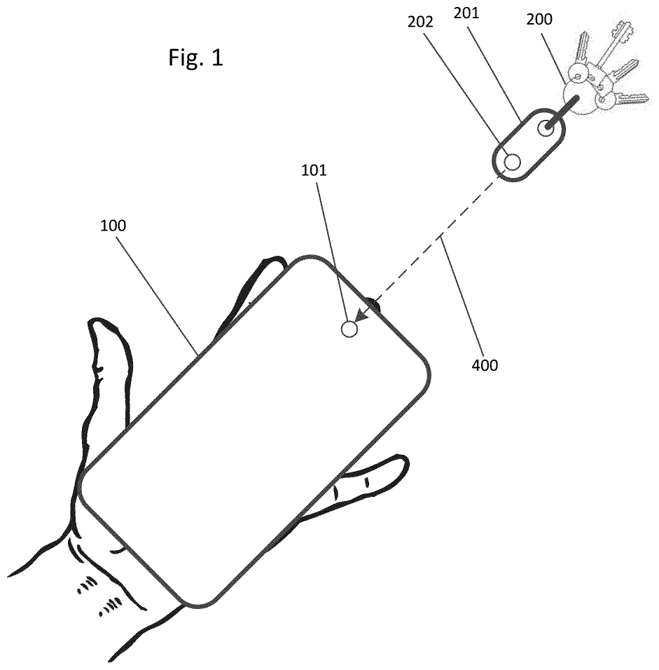

Turning now to FIG. 1, a first embodiment of the present invention is illustrated wherein the improved critical distance monitoring system utilizes a radio frequency (RF) transmitter 202 in dongle 201 attached to keychain 200. Using its RF receiver 101 cellular telephone 100 receives the signal 400 transmitted by RF transmitter 202. Since the received power of signal 400 is reduced due to distance and intervening radio frequency blocking structures, when the strength of signal 400 falls below a preset level, cellular telephone 100 signals an alarm. The alarm can be audible, visual, or tactile. Obviously, radio frequency (RF) transmitter 202 in dongle 201 attached to keychain 200 may be configured as an RF transmitter/receiver. Also, RF receiver 101 may be configured as an RF transmitter/receiver.

Obviously, a multiplicity of radio frequency (RF) transmitters 202 in a multiplicity of dongles 201 attached to a multiplicity of keychains 200 may interact with one RF receiver 101 in one cellular telephone 100. RF receiver 101 receives the signals 400 transmitted by the multiplicity of RF transmitters 202. Since the received power of each signal 400 is reduced due to distance and intervening radio frequency blocking structures, when the signal 400 falls below a preset level, cellular telephone 100 signals an alarm. The alarm can be audible, visual, or tactile. As discussed above, radio frequency (RF) transmitter 202 in dongle 201 attached to keychain 200 may be configured as an RF transmitter/receiver. Also, RF receiver 101 may be configured as an RF transmitter/receiver.

An application program (an “app”) operating on cellular telephone 100 may assign different types of alarms for different RF transmitters 202. The alarms can be audible, visual, or tactile. Similarly, the application program operating on cellular telephone 100 may assign different preset levels that the received power of each signal 400 must fall beneath to trigger an alarm for an RF transmitter 202. By altering the received power that each signal 400 must fall beneath to trigger an alarm one may alter the distance that the paired devices may be from one another before the alarm is triggered.

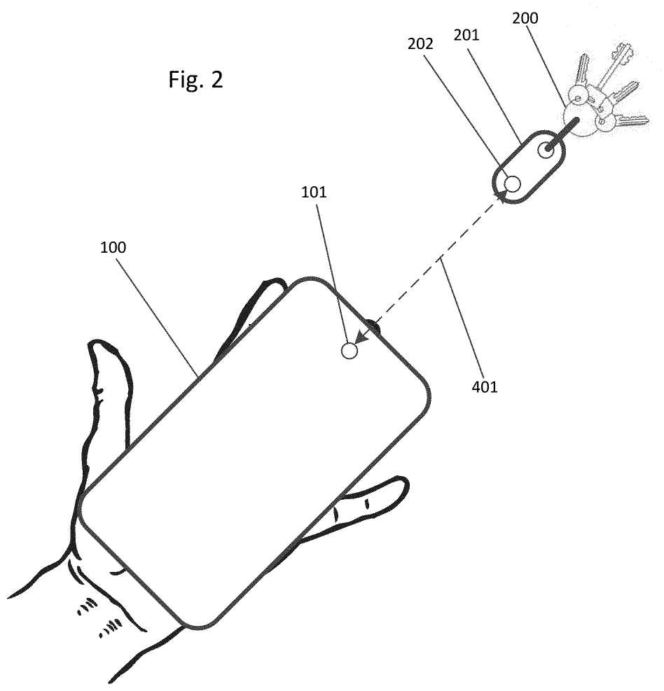

Turning now to FIG. 2, a second embodiment of the present invention is illustrated wherein the improved critical distance monitoring system utilizes RF transmitter/receiver 202 in a dongle 201 attached to keychain 200. Using its RF transmitter/receiver 101 cellular telephone 100 receives the signal 401 transmitted by the RF transmitter/receiver 202. When the received signal 401 falls below a preset level, cellular telephone 100 signals an alarm. The alarm can be audible, visual, or tactile. Simultaneously, using its RF transmitter/receiver 101 cellular telephone 100 also transmits a signal 401 which is received by RF transmitter/receiver 202 in dongle 201 attached to keychain 200. When the signal 401 falls below a preset level, RF transmitter/receiver 202 in dongle 201 attached to keychain 200 signals an alarm. The alarm can be audible, visual, or tactile.

Obviously, a multiplicity of RF transmitter/receivers 202 in a multiplicity of dongles 201 attached to a multiplicity of keychains 200 may interact with one RF transmitter/receiver 101 in one cellular telephone 100. RF transmitter/receiver 101 in cellular telephone 100 receives a multiplicity of signals 401 transmitted by the multiplicity of RF transmitter/receivers 202. Since the received power of each signal 401 is reduced due to distance and intervening radio frequency blocking structures, when the signal falls below a preset level, RF transmitter/receiver 202 signals an alarm. The alarm can be audible, visual, or tactile. Simultaneously, RF transmitter/receiver 101 receives a signal 401 transmitted by the multiplicity of RF transmitter/receivers 202. Since the received power of each signal 401 is reduced due to distance and intervening radio frequency blocking structures, when the signal falls below a preset level, cellular telephone 100 signals an alarm. The alarm can be audible, visual, or tactile.

An application program operating (an “app”) on cellular telephone 100 may assign different types of alarms for different RF transmitter/receivers 202. The alarms can be audible, visual, or tactile. Similarly, the application program operating on cellular telephone 100 may assign different preset levels that received power of each signal 401 must fall beneath to trigger an alarm for a particular RF transmitter/receiver 202. By altering the received power that each signal 401 must fall beneath to trigger an alarm one may alter the distance that the paired devices may be from one another before the alarm is triggered.

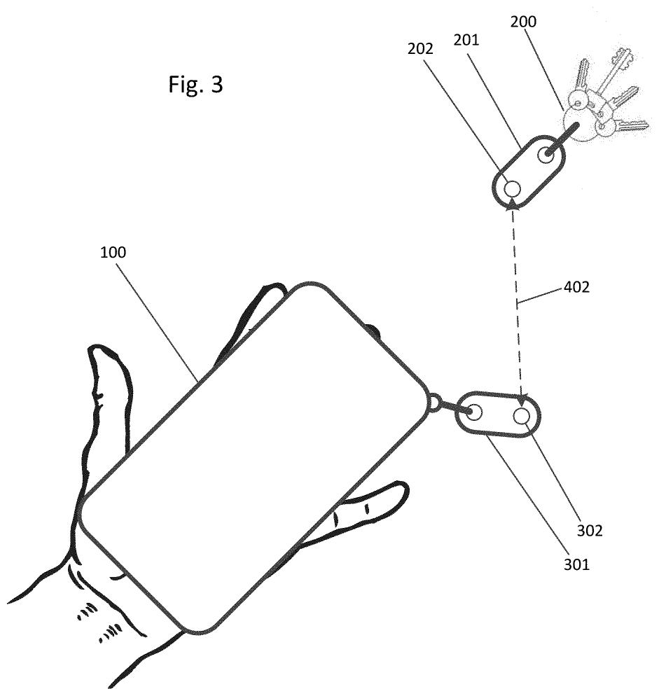

Turning now to FIG. 3 a third embodiment of the present invention is illustrated wherein the improved critical distance monitoring system utilizes first RF transmitter/receiver 202 in a dongle 201 attached to keychain 200 and second RF transmitter/receiver 302 in a dongle 301 attached to cellular telephone 100. Second RF transmitter/receiver 302 in dongle 301 attached to cellular telephone 100 receives the signal 402 transmitted by first RF transmitter/receiver 202 in dongle 201 attached to keychain 200. When the received signal 402 falls below a preset level, second RF transmitter/receiver 302 in dongle 301 attached to cellular telephone 100 signals an alarm. The alarm can be audible, visual, or tactile. First RF transmitter/receiver 202 in dongle 201 attached to keychain 200 receives the signal 402 transmitted by second RF transmitter/receiver 302 in dongle 301 attached to cellular telephone 100. When the received signal 402 falls below a preset level, first RF transmitter/receiver 202 in dongle 201 attached to keychain 200 signals an alarm. The alarm can be audible, visual, or tactile.

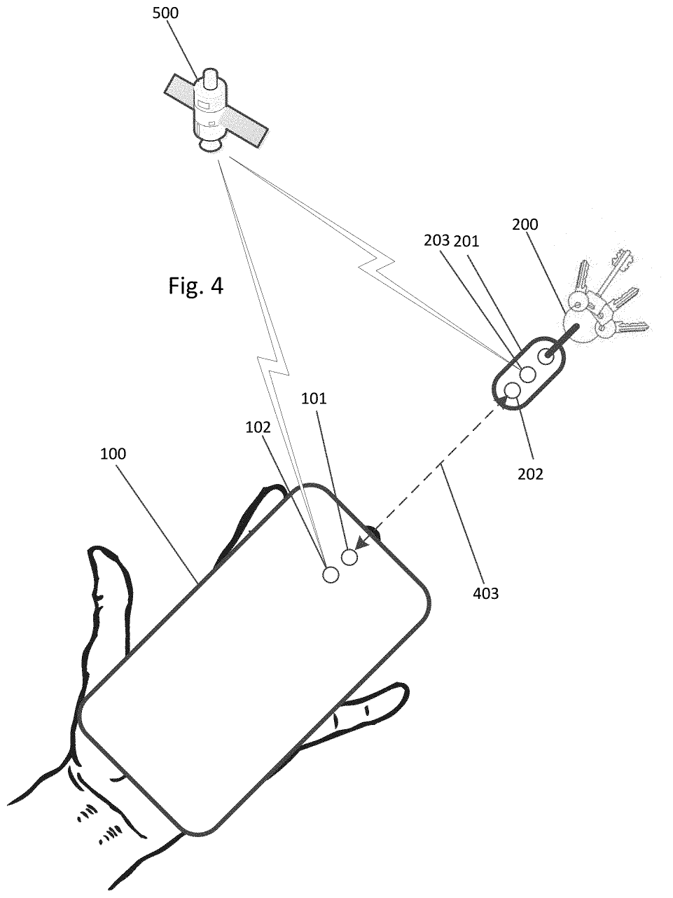

Turning now to FIG. 4, a fourth embodiment of the present invention is disclosed wherein the improved critical distance monitoring system utilizes first GPS receiver 203 in a dongle 201 attached to keychain 200 and second GPS receiver 102 built inside cellular telephone 100. First GPS receiver 203 in dongle 201 attached to keychain 200 receives the signal transmitted by GPS network 500. From this signal it calculates its location. Second GPS receiver 102 in cellular telephone 100 receives the signal transmitted by GPS network 500. From this signal it calculates its location. The cellular telephone 100 requests the location of dongle 201 using RF signal 403. This is transmitted by RF transmitter/receiver 202 using RF signal 403 and received by RF transmitter/receiver 101. Simultaneously, the location of cellular telephone 100 is transmitted by RF transmitter/receiver 101 using RF signal 403 and received by RF transmitter/receiver 202. If the distance between the cellular telephone 100 and the dongle 201 is greater than a preset value the cellular telephone 100 signals an alarm. The alarm can be audible, visual, or tactile. Similarly, if the distance between the dongle 201 and the cellular telephone 100 is greater than a preset value, RF transmitter/receiver 202 in dongle 201 signals an alarm. The alarm can be audible, visual, or tactile.

While specific devices and protocols have been referenced in the specification, those having skill in the art will recognize that all obvious variants are included by reference. For example, the invention disclosed includes references to one way and two-way RF communications links and using the strength of those links (signals) to determine the distance that the two items are from one another. Those having skill in the art will recognize that there are other methods of determining the distance between two items. For example, if the cellular telephone uses GPS to determine its location and the dongle attached to the keychain also uses GPS to determine its location, then the two devices can share this information and calculate their distance from one another. Using this distance, one or both devices may signal an alarm. The alarm can be audible, visual, or tactile. Also, the RF network used to communicate between the cellular telephone and the dongle may be a local area network, a cellular network, or a direct RF connection.

While a cellular telephone has been used to illustrate a device with its own RF transmitter/receiver, other devices with integral RF transmitter/receivers may be freely substituted. Obviously, a tablet computer or a personal computer may also be used in lieu of a cellular telephone. Other such devices may include briefcases, bags, purses, backpacks, and so on. Similarly, while a cellular telephone has been used to illustrate a generic device with a dongle containing an RF transmitter/receiver attached, any other type of device or item may be freely substituted. Such devices and items may be automobiles, tablet computers, cellular telephones, briefcases, bags, purses, backpacks, and so on.

What is claimed is:

1) An improved critical distance monitoring system comprising:
a) a first device with an RF transmitter in a dongle attached to a portable item; and
b) a second device with an RF receiver included within;
c) wherein the first device transmits an RF signal and the second device measures the signal strength of the signal it receives from the first device and the second device signals an alarm if the signal strength falls below a preset level.

2) An improved critical distance monitoring system of claim 1 wherein the portable item is a key chain.

3) An improved critical distance monitoring system of claim 1 wherein the second device is a cellular telephone.

4) An improved critical distance monitoring system of claim 1 wherein the second device is a tablet computer.

5) An improved critical distance monitoring system of claim 1 wherein the received signal strength is inversely proportional to the distance between the first device and the second device and indicative of the distance between the first device and the second device.

6) An improved critical distance monitoring system of claim 1 wherein the dongle is physically integrated into the portable item.

7) An improved critical distance monitoring system comprising:
a) a device with an RF transmitter/receiver in a dongle attached to a keychain; and
b) a cellular telephone with an RF transmitter/receiver included within;
c) wherein the cellular telephone measures the signal strength of the signal it receives from the RF transmitter/receiver in the dongle attached to the keychain and the cellular telephone signals an alarm if the signal strength falls below a preset level and the RF transmitter/receiver in the dongle attached to the keychain measures the signal strength of the signal it receives from the cellular telephone and the RF transmitter/receiver in the dongle attached to the keychain signals an alarm if the signal strength falls below a preset level.

8) An improved critical distance monitoring system comprising:
a) a first device with a first RF transmitter/receiver in a dongle attached to a keychain; and
b) a second device with a second RF transmitter/receiver in a dongle attached to it;
c) wherein the dongle attached to the second device measures the signal strength of the signal it receives from the RF transmitter/receiver in the first device and the dongle attached to a cellular telephone signals an alarm if the signal strength falls below a preset level and the RF transmitter/receiver in the dongle attached to the keychain measures the signal strength of the signal it receives from the RF transmitter/receiver in the dongle attached to the cellular telephone and signals an alarm if the signal strength falls below a preset level.

9) An improved critical distance monitoring system comprising:
a) a first device with a first RF transmitter/receiver and a GPS receiver in a dongle attached to a keychain; and
b) a second device with a second RF transmitter/receiver and a GPS receiver in a dongle attached to it;
c) wherein the dongle attached to the second device receives its latitude and longitude (location) from the GPS network and transmits its received location to the first device and the dongle attached to the first device receives its latitude and longitude (location) from the GPS network and transmits its received location to the second device and the second device calculates its distance from the first device and the first device calculates its distance from the second device and each device signals an alarm if the distance between the devices exceeds a preset distance.
